(19) United States
(12) Patent Application Publication
(10) Pub. No.: US 2006/0185611 A1
(43) Pub. Date: Aug. 24, 2006

(54) Robotic animal handling system for biosafety laboratories

(76) Inventors: Kent Copeland, Houston, TX (US); Jud Hedgecock, Friendswood, TX (US); Andy Dawson, League City, TX (US); Brian Hargrave, Webster, TX (US)

Correspondence Address: DUANE, MORRIS, LLP, 3200 SOUTHWEST FREEWAY, SUITE 3150, HOUSTON, TX, 77027, US

(21) Appl. No.: 11/312,727

(22) Filed: Dec. 20, 2005

Related U.S. Application Data
(60) Provisional application No. 60/637,810, filed on Dec. 21, 2004.

(51) Int. Cl. A01K 1/03

(52) U.S. Cl. 119/419

(57) ABSTRACT

The present inventions relate generally to the field of handling animal cages in biosafety laboratories (“BSL”), e.g. BSL 3 and 4 facilities. An animal storage facility for such facilities comprises, in typical configuration, a cage library automation system (CLAS) adapted to for storage and retrieval for animal cages, comprising a free-standing gantry; one or more animal cages; an animal cage rack adapted for insertion into the gantry and for selective retrieval and storage of the animal cage; a rack motor operatively in communication with the animal cage rack; a robotic arm adapted to transport the animal cage from the animal cage rack and a holding area; an end effector disposed about an end of the robotic arm and adapted for manipulation of the animal cage; and a controller operatively in communication with the rack motor and the robotic arm; and a holding area adapted to provide a cage queue containing a predetermined number of animal cages to provide a buffer for a BSL worker when processing an animal for a particular experiment protocol without having to wait for the robotic arm to retrieve the animal cage. Users can use the CLAS to retrieve, manipulate, and/or insert an animal cage into the animal cage racks either manually or using the robotic arm.

### FIELD OF INVENTION

This application claims priority from provisional application Ser. No. 60/637,810 filed Dec. 21, 2004.

### FIELD OF INVENTION

The present inventions relate generally to the field of handling animal cages and more specifically to handling animal cages in biosafety laboratories (“BSL”), e.g. BSL 3 and 4 facilities.

### BACKGROUND OF THE INVENTION

According to government guidelines, if experimental animals are used, institutional management must provide facilities, staff, and established practices that reasonably ensure appropriate levels of environmental quality, safety, and care. In these environments, laboratory animal facilities are simply a special type of laboratory which may require biosafety levels (facilities, practices, and operational requirements) for working with infectious agents in vivo and in vitro.

However, the animal room can present some unique problems. In the microbiological laboratory, hazardous conditions are caused by personnel or by the equipment being used. In the animal room, the activities of the animals themselves can present new hazards. Animals may generate aerosols, they may bite and scratch, and they may be infected with a zoonotic disease. Ideally, facilities for laboratory animals used in studies of infectious or noninfectious disease should be physically separate from other activities such as animal production and quarantine, clinical laboratories, and especially from facilities providing patient care.

It is desirable to have a cargo handling system that is adaptable for use in BSL facilities, especially BSL level 3 and 4 facilities, to allow insertion, removal, and monitoring of cages stored in a dense configuration using rack motors and a robotic arm.

### BRIEF DESCRIPTION OF THE DRAWINGS

The various drawings supplied herein may be representative of one or more embodiments of the present inventions.

FIG. 1 illustrates a view of an exemplary Cage Library Automation System (CLAS) in partial perspective.

FIG. 2 illustrates a second view of an exemplary Cage Library Automation System (CLAS) in partial perspective.

FIG. 3 is a detail in partial perspective of a portion of an exemplary end-effector.

FIG. 4 illustrates a front view of an exemplary animal cage.

FIG. 5 illustrates a side view in partial perspective of animal cages in a cage rack with an exemplary robotic arm.

FIG. 6 illustrates a side view in partial perspective of a CLAS workstation area.

FIG. 7 illustrates a partial side view of the CLAS with a user manually checking a cage.

### DETAILED DESCRIPTION OF EXEMPLARY EMBODIMENTS OF THE INVENTION

As used herein, the “animal” cages may be used with any biological matter, e.g. animals or plants, whether or not described as merely an animal. Thus, “animal,” as used herein, means either an animal or a plant or any other substance to be handled in a biosafety laboratory facility.

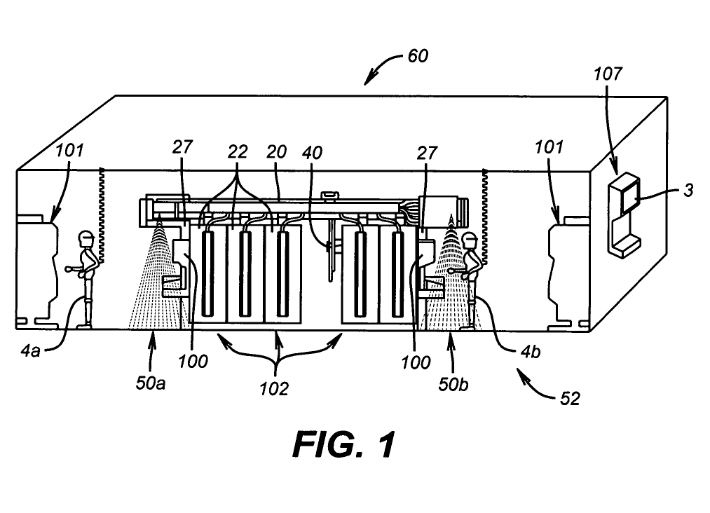

Referring now to FIG. 1, in a preferred embodiment, an exemplary Cage Library Automation System (CLAS) according to the present inventions is shown. CLAS system 1, a densely packed automated storage and retrieval system for animal cages, is typically adapted for use in a biosafety laboratory (“BSL”) 3 or 4 facility 52. In currently envisioned embodiments, CLAS system 1 may be installed in BSL facility 52 without requiring modifications to infrastructure of BSL facility 52.

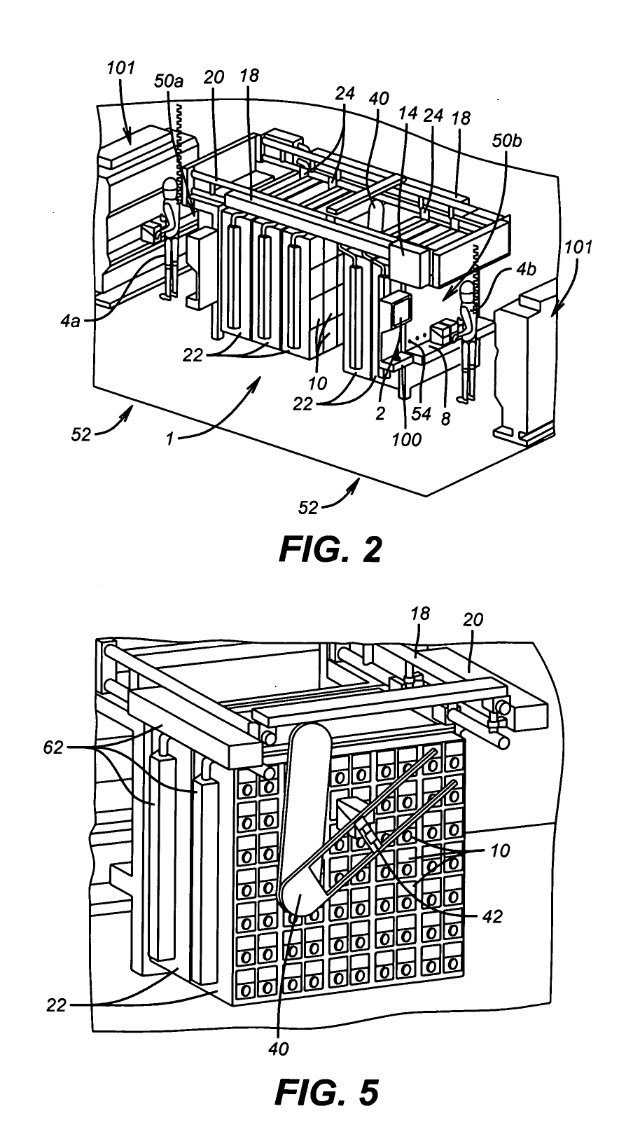

In a preferred embodiment, CLAS 1 comprises free-standing gantry 20; animal cages 10 (FIG. 2) adapted for selective insertion into, storage in, and removal from animal cage racks 22 which are further adapted for insertion into gantry 20; rack motor 24 operatively in communication with animal cage rack 22; robotic arm 40 adapted to transport animal cage 10, e.g. along a top track back and forth from animal rack 22 and holding area 50 (shown in FIG. 1 as either 50a or 50b) at the ends of the gantry connected to the gantry structural supports 27; and controller 14 (not shown in the figures) operatively in communication with rack motor 24 and robotic arm 40.

CLAS 1 may be used to automate the insertion, removal, and monitoring of animal cages 10 stored in a dense configuration, e.g. using rack motors 24 and robotic arm 40. In certain contemplated embodiments CLAS 1 is able to utilize commercial off-the-shelf animal cage racks 22 mounted to gantry 20 which may be a free-standing structure. A predetermined set of electronics (not shown in the figures) useful for operating CLAS 1 may be present and hermetically sealed to withstand gas and fluid decontamination wash-down.

CLAS system 1 is typically part of animal storage facility 60 comprising CLAS system 1 and one or more holding areas 50. Animal storage facility 60 may further comprise data transmission system 70 (not shown in the figures) adapted to wirelessly provide functions and controls from external command and control workstation 107 such as with video and/or non-video data or a combination thereof. In certain embodiments, CLAS system 1 may be operated at remote external command and control workstation 107 which may be located outside BSL holding area 50; at user workstation 100 which may be located adjacent to BSL holding area 50; or the like; or a combination thereof. Further, a graphical user interface (GUI), joystick, and large buttons at user workstation 100 may be used to provide user-friendly control of CLAS system 1 by allowing users 4a, 4b in BSL protective suits to input information or otherwise manipulate the system.

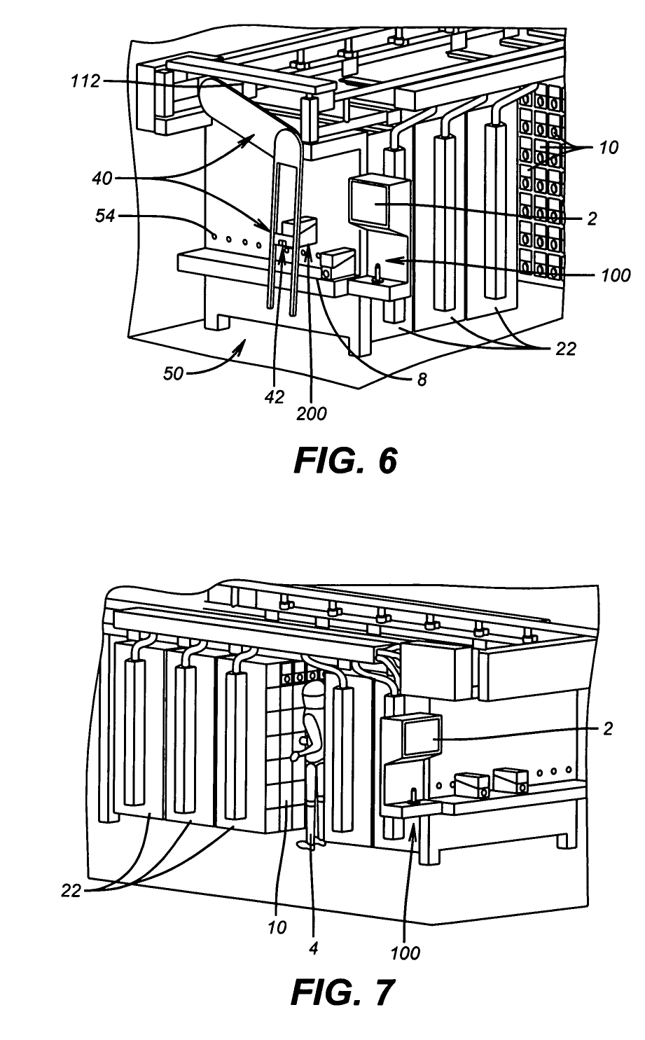

One or more biosafety cabinets 101 may be present with typical configurations have one on either end of CLAS 1, e.g. proximate or directly across from holding areas 50a and 50b, to allow user 4 to access animal cage 10, place it in a desired biosafety cabinet 101, perform animal or cage tasks, and then return animal cage 10 to holding area 50 for installation back in animal rack 22 using robotic arm 40. In a preferred embodiment, each holding area 50 provides up to a ten cage queue 8 (FIG. 6) to provide a buffer for use 4 in processing animals for a particular experiment protocol without having to wait for robotic arm 40 to retrieve each animal cage 10.

One or more user workstations 100 may also be present. Further, a safety system may be located proximate one or more holding areas 50 and may be used to detect activity of user 4 inside predetermined safety zone, e.g. including holding area 50a or 50b. In certain of these embodiments, robotic arm 40 is inhibited from entering the safety zone when user 4 is present or within a certain area range of the safety zone, e.g. user 4b.

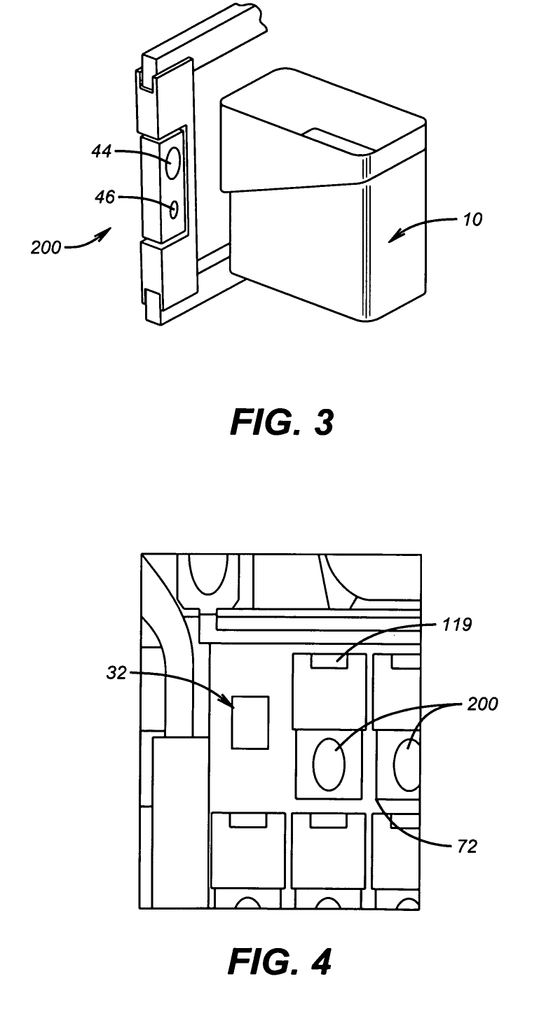

Referring now to FIG. 2 and FIG. 3, each holding area 50 may be further adapted to provide cage queue 8 (FIG. 6) for containing a predetermined number of animal cages 10 and, thus, to provide a buffer for user 4, e.g. 4b, when processing an animal without having to wait for robotic arm 40 to retrieve animal cage 10, such as for a particular experiment protocol.

Animal cage 10 may be transported along top track 18 back and forth from animal cage racks 22 and one or more holding areas 50, e.g. 50a or 50b, using robotic arm 40. In certain embodiments, robotic arm 40 typically comprises multi-purpose end-effector 42 (FIG. 4), disposed proximate an end of robotic arm 40; camera 44 (FIG. 3); and radio frequency (RF) transceiver 46 (FIG. 3) which is further adapted to provide cage access, inspection, animal monitoring, or the like, or a combination thereof. Robotic arm 40 may use its multi-purpose end-effector 42, camera 44, RF transceiver 46 for use in cage access, inspection, animal monitoring, and the like, or a combination thereof.

Additionally, an RF device such as an RF data logger capsule (not shown in the figures) may be used for subcutaneous implantation into an animal to aid in obtaining and recording animal body temperature, animal heart rate, animal gross motor activity, or the like, or a combination thereof. In these configurations, RF transceiver 46 may be placed proximate animal cage 10 and wirelessly download data from the RF data logger capsule, e.g. to gather individual animal data. For example, a subcutaneous implanted RF data logger capsule may be used to obtain and/or record data such as animal body temperature, heart rate, and gross motor activity. Individual animal data may be gathered by robotic arm 40 when RF transceiver 46 is placed proximate animal cage 10 and wirelessly download data from the RF data logger capsule.

Visual observation of individual animals while stored in animal cage rack 22 may be provided by camera 44 (FIG. 3) which may be present to provide visual observation of individual animals which are stored in animal cages 10 such as via video link 45 (not shown in the figures) which may be transmitted to monitor 2 disposed inside BSL lab 52, remote command and control workstation 107 (FIG. 1) disposed external to BSL facility 52, or the like, or a combination thereof. Animal cages 10 may be monitored and manipulated individually at each cage location or they may be transported to one or more holding areas 50, e.g. located at each end of CLAS system 1, to be accessed by BSL user 4 such as for cleaning or other research activities.

Referring now to FIG. 4, animal cage 10 (FIG. 2) may be a commercial off-the-shelf animal cage 10. In certain embodiments, animal cage 10 further comprises light source 32, e.g. a light emitting diode (“LED”) array, adapted to provide circadian rhythm lighting conditions when animal cage 10 is placed into animal cage rack 22 (FIG. 1) and abutted to another animal cage 10 placed into animal cage rack 22.

Referring now to FIG. 5, in certain embodiments, animal storage facility 60 (FIG. 1) further comprises stand-alone air-filtering and handling system 62. In these embodiments, CLAS 1 (FIG. 1) may be configured as a self-contained module that only requires power with no additional modifications to a BSL facility 52 (FIG. 2).

Referring now to FIG. 6, holding area 50 may further comprise cage slots adapted to provide one or more gas ports 54 to interface with a predetermined animal cage 10. Gas ports 54 may be used to circulate fresh, filtered air through a predetermined animal cage 10; to administer a predetermined amount of an anesthetic gas to the predetermined animal cage 10 thereby rendering the animal inside animal cage 10 unconscious and allowing BSL user 4 (FIG. 1) to safely handle them; or the like; or a combination thereof.

As illustrated in FIG. 7, robotic arm 40 (FIG. 1) may be manually disabled and racks 22 manually manipulated by user 4 when robotic arm 40 is disabled.

In the operation of an exemplary embodiment, referring generally to FIGS. 1 and 2, an animal placed into animal cage 10 (FIG. 2) may be stored and retrieved by locating biosafety cabinet 101 (FIG. 2) proximate holding area 50 (FIG. 2) to allow user 4 (FIG. 2) to access to animal cage 10. Robotic arm 40 (FIG. 1) places animal cage 10 in biosafety cabinet 101. Once located in biosafety cabinet 101, a desired animal or cage task may be performed, such as removing an anesthetized animal from the cage or cleaning animal cage 10. When desired, animal cage 10 is returned to holding area 50 and installed back into CLAS system 1 using robotic arm 40.

User 4 (FIG. 2) may be allowed to request a desired animal cage 10 (FIG. 2) such as via a graphical user interface (“GUI”) from console 3 at remote command workstation 107 (FIG. 1). Once requested, robotic arm 40 (FIG. 2) is moved to a position proximate the requested animal cage 10 and is used to unlock cage slot fastener 119 (FIG. 4) disposed proximate the requested animal cage 10. End-effector 42 (FIG. 5) is then locked onto the requested animal cage 10 and robotic arm 40 used to remove the requested animal cage 10 from its slot in CLAS system 1.

Once removed, the removed animal cage 10 is stowed beside robotic arm 40 in such a way as to allow animal cage 10 and robotic arm 40, which is used to transport the removed animal cage 10 to holding area 50 (FIG. 2), in the space above or below animal racks 22, e.g. along a gap between animal racks 22 and the floor. As shown in FIG. 2, a configuration is illustrated using the space above animal racks 22. User 4 (FIG. 2) may be allowed at any desired time to move to holding area 50 to retrieve animal cage 10. As discussed above, in certain embodiments, when user 4 is detected as being proximate holding area 50, robotic arm 40 is automatically disabled and user 4 may be allowed to remove animal cage 10 from holding area 50. Where robotic arm 40 has been disabled, robotic arm 40 may be automatically enabled once user 4 clears holding area 50.

A plurality of animal cages 10 (FIG. 1) may be monitored and manipulated. For example, a monitor may be mounted to end-effector 42 (FIG. 5) where the monitor is camera 44 (FIG. 3), RF transceiver 46 (FIG. 3), or the like, or a combination thereof. The monitor may be used to perform numerous tasks, e.g. monitor animal activity, read a bar code on animal cage 10, or the like, or a combination thereof. The monitoring and manipulating may occur individually at each location of each animal cage 10, by transportation of animal cage 10 to at a predetermined holding area 50 at each end of CLAS system 1 where animal cage may be accessed by BSL user 4, e.g. for cleaning or other research activities, or the like, or a combination thereof.

Non-video data and/or video data may be transmitted, e.g. to external command and control workstation 107 (FIG. 1), using wireless technology.

Researchers, e.g. user 4, may use a graphical user interface (“GUI”) to enter a monitoring protocol, an individual animal, or the like, or a combination thereof. For example, a transported animal cage 10 may be interfaced to one or more gas ports 54 (FIG. 6) such as for animal anesthetization. The GUI may further be used to aid in translating a position of robotic arm 40 to a position proximate a desired animal cage 10 at a predetermined interval. Once so located, the monitor may be directed towards the desired animal cage 10 and data obtained from that animal cage 10. A predetermined set of the data may be recorded and software used to analyze the recorded data. In certain embodiments, researcher 4 is automatically notified, e.g. by the software, if specified conditions are met.

User 4 may place animal cage 10 in holding area 50, e.g. once work with the animal or cage has been completed. Robotic arm 40 may be enabled once user 4 clears holding area 50 and positioned proximate animal cage 10. In certain embodiments, a bar-code associated with animal cage 10 made be read by robotic arm 40 to identify animal cage 10, e.g. using a bar code sensor or reader located proximate an end of robotic arm 40.

To return the animal and its animal cage, 10, end-effector 42 disposed about an end of robotic arm 40 is locked onto animal cage 10 and then robotic arm 40 used to remove the locked animal cage 10 from holding area 50. Animal cage 10 is stowed beside robotic arm 40 in such a way as to allow robotic arm 40 and stowed animal cage 10 to be transported to a desired storage slot in animal rack 22 in the space above or below animal racks 22. Once located proximate the desired storage slot, transported animal cage 10 is placed, using robotic arm 40, into the storage slot and secured in that slot.

In certain embodiments, operation of the CLAS is provided at a remote command and control workstation, i.e. 107, outside facility 52 and at user workstations 100 adjacent to the holding area 50. At workstations 100, a graphical user interface (GUI), joystick, and large buttons may be present to provide user-friendly control of CLAS 1 by allowing users 4 in bulky BSL protective suits to easily input information. When required, animal racks 22 can be manually manipulated and robotic arm 40 disabled (e.g., FIG. 7).

In certain embodiments, a stand-alone air-filtering system makes CLAS system 1 a self-contained module that only requires power with no additional modifications to BSL facility 52.

The foregoing disclosure and description of the inventions are illustrative and explanatory. Various changes in the size, shape, and materials, as well as in the details of the illustrative construction and/or a illustrative method may be made without departing from the spirit of the invention.

1. A cage library automation system (CLAS) adapted for storage and retrieval of one or more animal cages, comprising:
a. a free-standing gantry;
b. an animal cage;
c. an animal cage rack adapted for insertion into the gantry and for selective retrieval and storage of the animal cage;
d. a rack motor operatively in communication with the animal cage rack;
e. a robotic arm disposed proximate the gantry and adapted to transport the animal cage from the animal cage rack and a holding area; and
f. a controller operatively in communication with the rack motor and the robotic arm.

2. The CLAS system of claim 1, wherein the CLAS system is further adapted for use in at least one of (i) a biosafety laboratory (“BSL”) 3 facility or (ii) a BSL 4 facility.

3. The CLAS system of claim 2, wherein the CLAS system is adapted to be installed in the BSL facility without requiring modifications to infrastructure of the BSL facility.

4. The CLAS system of claim 1, wherein the animal cage rack is a commercial off-the-shelf animal cage rack.

5. The CLAS system of claim 4, wherein the animal cage rack further comprises a light source adapted to provide circadian rhythm lighting conditions when the animal rack is placed into the animal cage rack and abutted to another animal rack placed into the animal cage rack.

6. The CLAS system of claim 5, wherein the light source comprises an LED array.

7. The CLAS system of claim 1, wherein the robotic arm further comprises:
a. an end effector disposed proximate an end of the robotic arm, the end effector adapted for manipulation of the animal cage;
b. a camera; and
c. a radio frequency (RF) transceiver adapted to provide at least one of (i) cage access, (ii) inspection, and (iii) animal monitoring.

8. The CLAS system of claim 7, wherein the camera is adapted to provide visual observation of an animal cage position relative to the camera or an individual animal stored in the animal cage via a video link transmitted to at least one of (i) a monitor inside a lab and (ii) a remote command and control workstation external to a BSL facility.

9. An animal storage facility, comprising:
a. a cage library automation system (CLAS) adapted to for storage and retrieval for animal cages, comprising:
1. a free-standing gantry;
2. an animal cage;
3. an animal cage rack adapted for insertion into the gantry and for selective retrieval and storage of the animal cage;
4. a rack motor operatively in communication with the animal cage rack;
5. a robotic arm disposed proximate the gantry and adapted to transport the animal cage from the animal cage rack and a holding area;
6. an end effector disposed about an end of the robotic arm and adapted for manipulation of the animal cage; and
7. a controller operatively in communication with the rack motor and the robotic arm; and
b. a holding area adapted to provide a cage queue containing a predetermined number of animal cages to provide a buffer for a biosafety laboratory (“BSL”) worker when processing an animal for a particular experiment protocol without having to wait for the robotic arm to retrieve the animal cage.

10. The animal storage facility of claim 9, wherein the holding area further comprises a cage slot adapted to provide a gas port to interface with a predetermined animal cage.

11. The animal storage facility of claim 10, wherein the gas port is adapted to at least one of (i) circulate fresh, filtered air through the predetermined animal cage and (ii) to administer a predetermined amount of an anesthetic gas to the predetermined animal cage, thereby rendering the animals unconscious and allowing the BSL worker to safely handle them.

12. The animal storage facility of claim 11, further comprising a stand-alone air-filtering system whereby the CLAS is a self-contained module that only requires power with no additional modifications to a BSL facility.

13. The animal storage facility of claim 9, wherein a predetermined set of electronics is hermetically sealed to withstand gas and fluid decontamination wash-down.

14. The animal storage facility of claim 9, further comprising a data transmission system adapted to wireless provide an external Command and Control workstation with at least one of (i) non-video data and (ii) video data.

15. The CLAS system of claim 9, further comprising an RF data logger capsule adapted for subcutaneous implantation into an animal, the RF data logger capsule further adapted to record at least one of (i) animal body temperature, (ii) animal heart rate, and (iii) animal gross motor activity.

16. The CLAS system of claim 15, wherein the RF transceiver is adapted to be placed proximate an animal cage and wirelessly download data from the RF data logger capsule to gather individual animal data.

17. A method of storing and retrieving an animal, comprising:
a. locating a biosafety cabinet proximate a biosafety laboratory (“BSL”) holding area to allow a worker to access an animal cage;
b. placing the animal cage in the biosafety cabinet using a robotic arm;
c. performing a desired animal or cage task;
d. returning the animal cage to the holding area using the robotic arm; and
e. installing the animal cage back in a cage library automation system (CLAS) adapted for storage and retrieval of one or more animal cages using the robotic arm.

18. The method of claim 17, further comprising using a graphical user interface (GUI), joystick, and large buttons at the user workstation to provide user-friendly control of the system by allowing users in BSL protective suits to input information.

19. The method of claim 17, further comprising:
a. allowing the robotic arm to be manually disabled; and
b. allowing the racks to be manually manipulated when the robotic arm is disabled.

20. The method of claim 17, further comprising operating the CLAS at least one of (i) a remote Command and Control Workstation located outside the BSL holding area or (ii) at a user workstation located adjacent to the BSL holding area.

21. The method of claim 20, further comprising transmitting data and video to the external Command and Control workstation using wireless technology.

22. The method of claim 17, further comprising transporting a cage along a top track back and forth from the cage racks and the Holding Areas using the robotic arm.

23. The method of claim 17, further comprising monitoring and manipulating a plurality of animal rack cages.

24. The method of claim 17, wherein the monitoring and manipulating occurs at least one of (i) individually at each cage location and (ii) by transportation to at a predetermined holding area at each end of the CLAS to be accessed by a BSL staff member for cleaning or other research activities.

25. The method of claim 17, further comprising:
a. providing a safety system at least partially within the rack storage area to detect worker activity inside a predetermined “safety zone;” and
b. inhibiting the robot arm from entering the predetermined “safety zone.”

26. The method of claim 17, further comprising:
a. mounting a monitor to a robot arm end-effector, the monitor comprising at least one of (i) a camera and (ii) an RF transceiver; and
b. using the monitor to at least one of (i) monitor animal activity and (ii) read a bar code on the animal cage.

27. The method of claim 17, further comprising:
a. allowing a researcher use a graphical user interface (“GUI”) to at least one of (i) enter a monitoring protocol and (ii) select an individual animal;
b. translating a position of the robotic arm to a position proximate a desired animal cage at a predetermined interval;
c. directing a monitor towards the desired animal cage;
d. recording a predetermined set of data; and
e. using software to analyze the recorded data.

28. The method of claim 17, further comprising automatically notifying a researcher if specified conditions may be met.

29. The method of claim 17, wherein the monitor comprises at least one of (a) a camera or (b) an RF transceiver.

30. The method of claim 17, further comprising:
a. allowing the user to request a desired animal cage via a graphical user interface (“GUI”) at a workstation;
b. moving the robotic arm to a position proximate the requested animal cage using images from the camera and processing the images to measure the position of the animal cage relative to the robotic arm end-effector;
c. using the robotic arm to unlock a cage slot fastener disposed proximate the requested animal cage;
d. locking an end-effector located proximate an end of the robotic arm onto the requested animal cage;
e. removing the requested animal cage from a slot in the CLAS;
f. stowing the removed animal cage in a position that allows the robotic arm with the animal cage to travel through the rack storage area unobstructed to a cage holding area; and
g. using the robotic arm to transport the removed cage to the cage holding area.

31. The method of claim 30, further comprising interfacing the transported cage to a gas port for animal anesthetization.

32. The method of claim 30, further comprising:
a. allowing the user to move to the holding area to retrieve cage;
b. detecting when the user is proximate the holding area;
c. automatically disabling the robotic arm when user is detected proximate the holding area.

33. The method of claim 32, further comprising:
a. allowing the user to remove the cage from the holding area; and
b. automatically enabling the robotic arm once the user clears the holding area.

34. The method of claim 17, further comprising
a. allowing the user to place the animal cage in the holding area;
b. enabling the robotic arm once the user clears the holding area;
c. positioning the robotic arm proximate the animal cage using images from the camera and processing them to measure the position of the animal cage relative to the robotic arm end-effector;
d. reading a bar-code associated with the animal cage by the robotic arm to identify animal cage;
e. locking an end-effector disposed about an end of the robotic arm onto the animal cage;
f. removing the locked cage from the holding area;
g. stowing the animal cage in a position that allows the robotic arm to travel with the animal cage through the rack storage area unobstructed to a storage slot on the rack;
h. transporting the stowed cage to the storage slot on rack;
i. placing the transported cage using the robotic arm into a predetermined storage slot in CLAS rack; and
j. refastening the stored cage.
